(19) United States
(12) Patent Application Publication
(10) Pub. No.: US 2012/0098526 A1
(43) Pub. Date: Apr. 26, 2012

(54) METHOD FOR IDENTIFYING CAPSULES IN A BEVERAGE PRODUCING DEVICE WITH MAGNETICALLY-RESPONSIVE IDENTIFIER

(75) Inventors: Peter Bucher, Besazio (CH); Alessandro Brazzola, Gorla (CH); Castel S. Pietro, Gorla (CH); Alexandre Kollep, Lutry (CH); André Jung, La Croix sur Lutry (CH)

(73) Assignee: NESTEC S.A., Vevey (CH)

(21) Appl. No.: 13/379,628

(22) PCT Filed: Jun. 21, 2010
(86) PCT No.: PCT/EP2010/058683

§ 371 Date: Dec. 20, 2011

(30) Foreign Application Priority Data
Jul. 3, 2009 (EP) 09164589.5

(51) Int. Cl. G01N 27/74

(52) U.S. Cl. 324/204

(57) ABSTRACT

A method for identifying capsules in a beverage producing device by providing a capsule comprising at least one identifier attached thereto or embedded therein; the identifier comprising a magnetically-responsive material, providing detecting means in the beverage producing device to detect the identifier including at least one emitting coil and at least one receiving coil, positioning the identifier in the magnetic field thereby altering the magnetic signal resulting therefrom, emitting a magnetic signal from the at least one emitting coil, detecting an altered signal by the receiving coil and identifying the capsule according to the alteration provided to the magnetic signal.

The present invention relates to a method for identifying capsules in a beverage producing device using a magnetically detectable identifier

Beverage producing systems have been developed for many years on the basis of portioned beverages, in particular, capsules containing a predetermined dose of beverage ingredient such as coffee, tea, milk powder and the like. The numerous advantages of such systems have been widely recognized, in particular, their convenience of use, clean operations and better controlled quality of the brewed beverage delivered.

The term “capsule” is here used to designate packets, pods or cartridges as well.

It is known to associate a radio frequency (RF) identifier to the capsule for the purpose of recognizing the capsule which is inserted in the device such as by a reader. Such identification allows changing particular operations, in the beverage producing device, in response to the detection of the identifier. For instance, brewing operations can be modified accordingly for adapting them to the type of capsule detected. For instance, brewing parameters, such as water temperature, the beverage volume or others, can be changed.

WO02/28241 relates to an encoded coffee packet including a machine interpretable feature on the capsule, for instance, electromagnetically detectable, e.g., a magnetic data storage medium. The machine interpretable feature is positioned at the rim or seam of the packet.

FR2912124 relates to a portioned package for preparation of a beverage comprising two flexible walls connected by their seam and comprising an RFID tag for contactless reading which is positioned in a reinforced peripheral portion at the seam of the package.

EP1890271A1 relates to a method of controlling the dispensing of an infusion product with a container for a product dose and an RFID tag associated to a respective number of containers.

GB 2397510 relates to a cartridge and machine for the preparation of beverage wherein each cartridge carries a code comprising a plurality of data bits which barcode is read by a beverage preparation machine upon insertion of the cartridge in the machine.

WO 2005/044067 relates to an apparatus enabling the traceability of the content of a receptacle and its origin wherein the receptacle comprises an optical or magnetic code containing information as to the content or origin of the receptacle which are read by an external reader, e.g., comprising a magnetic head. The code can be a metallic wire or ribbon containing recorded information in magnetic format.

The prior art solutions typically contemplate the association of a contactless identifier such as a radio-frequency tag with the portioned package. The package forms generally the support for the tag and can generally be produced during manufacturing of the package.

However, the code of magnetic storage media or RFID tags are not fully secured against forgery. RFID technology is also relatively expensive.

EP1755090A1 relates to a device for identification and verification of items with refundable deposit in particular for recycling glass or PET bottles using a magnetic, electromagnetic and/or optical identification means such as by labels applied onto the items.

U.S. Pat. No. 6,747,559 relates to glass-coated amorphous magnetic micro-wire marker for an article surveillance.

There is a need for a simpler, more economical and more secured method for recognizing capsules in a beverage producing device. According to a first aspect, the present invention relates to a method for identifying capsules in a beverage producing device comprising:

providing a capsule comprising at least one identifier attached thereto or embedded therein,

providing detecting means in the beverage producing device to detect the identifier and,

recognizing the capsule present in the device by its identifier,

optionally controlling parameters of the beverage producing device based on the recognized capsule,

the method further comprising:

providing the identifier with a magnetically-responsive material,

providing detecting means of the beverage producing device including at least one emitting coil and at least one receiving coil,

emitting a magnetic signal from the at least one emitting coil,

positioning the identifier in the magnetic field thereby altering the magnetic signal resulting therefrom and,

detecting an altered signal by the receiving coil and identifying the capsule according to the alteration provided to the magnetic signal.

In another possible aspect, the invention relates to a method for identifying capsules in a beverage producing device comprising:

providing different types of capsules wherein each type comprises at least one identifier attached thereto or embedded therein,

providing detecting means in the beverage producing device to detect the identifier and,

recognizing the type of capsules present in the device by discriminating the identifier relatively to other identifiers corresponding to the other types of capsules,

optionally controlling parameters of the beverage producing device based on the recognized type of capsules,

wherein the method comprises:

providing the identifier with a magnetically-responsive material which composition differs for each type of capsule but is identical for capsules of the same type,

providing detecting means of the beverage producing device including at least one emitting coil and at least one receiving coil,

emitting a magnetic signal from the at least one emitting coil,

altering the magnetic signal by passing it through the magnetically-responsive material,

detecting an altered signal by the receiving coil,

analysing the altered magnetic signal and identifying the type of capsule according to predetermined patterns of altered magnetic signals.

Such method procures several advantages compared to prior art, in particular, it is much simpler and more economical than RFID technology. Importantly, contrary to barcodes, RFID tags or other data storage media, the identifier according to the method of the invention is less easy to falsify because the principle of altering the magnetic signal is essentially based on the material composition of the identifier which differs for each type of capsule. As such material composition provides its own “signature” corresponding to a unique alteration pattern of the magnetic signal, this signature cannot be easily reproduced unless the specific material composition of the identifier can be duplicated.

More particularly, the magnetic signal is altered by the identifier providing at least one clearly identifiable Barkhausen jump (also called “Barkhausen pulse”) affecting the signal as resulting from the magnetically-responsive material placed in the magnetic field. Therefore, an alteration of the magnetic signal relates to at least one identifiable parameter of a Barkhausen jump of the magnetic signal, such as its position, duration, amplitude and combinations thereof.

The analysing operation comprises the comparison of such Barkhausen jump or altered magnetic response with a number of reference magnetic patterns; each one corresponding to different types of capsules.

Preferably, the magnetically-responsive material is formed from at least one wire and/or band.

In possible mode, the material is formed from a combination of wires or bands.

Preferably, the wire and/or band comprises a magnetically-responsive alloy having a predetermined dimension and a specific composition.

The alloy is preferably a metal based alloy essentially constituted of metal elements and possibly other additional magnetically-responsive elements. Other additional magnetically-responsive elements can be semi-metals or metalloids such as silicon or boron.

The magnetically-responsive alloy can be coated by a glass coating to form a glass coated wire.

Preferably, the identifier has a predetermined location onto or in the capsule.

An important advantage of such method results from the difficulty to duplicate the identifier thus resulting in the impossibility to reproduce the same alteration of the magnetic signal. As there is no transfer of data bits between the identifier and device, the signal is simpler to treat, the discrimination between the different types of capsules bearing different identifiers is more reliable and the system as whole is more secured.

As aforementioned, the identifier can take different shapes such as wire(s), band(s) or combinations thereof. In a mode, the identifier comprises at least one wire of metal alloy having determined dimensions (i.e., length, diameter) so to deliver a reproducible signal. More particularly, the magnetically-responsive material is made of at least one wire containing different chemical elements from the periodic table, in particular metals or other magnetically-responsive elements such as metalloids. The wire has a glass coating containing these elements. For instance, the wire contains metals such as Cobalt, Chrome, Iron or other additional magnetically-responsive elements such as Silicium or Boron, in different ratios, thereby forming different combinations. Each combination of metals forms a specific metal based alloy.

Preferably, the determined length of the wire is comprised between 5 and 15 mm, most preferably between 8 and 12 mm. Preferably, the diameter of the wire is comprised between 10 and 200 microns, preferably 25 and 75 microns. Importantly, the dimension of the wire should be precisely controlled to be identical for, at least, the capsules of the same type. Preferably, all the wires of identical composition have the same dimension (length/diameter) and are placed in the same relative position in the capsule. As a result, a reproducible Barkhausen effect can be expected and the capsule is properly recognized. An advantage is also that the identifier is so small that it can be more easily integrated to the capsule without affecting the geometry and/or dimensions of the capsule, either in the packaging or the product (e.g., coffee powder).

The method contemplates the operation of detecting of the identifier when the capsule is inserted in the brewing unit. The detection is preferably carried out when the capsule is static (i.e., not moving) in the brewing unit, e.g., the capsule seating in the capsule holder or in guiding means between the capsule holder and the water injection part. For this, the emitting and receiving coils are preferably placed in the vicinity of the brewing unit.

In a mode, the magnetic field is provided by two emitting coils. The two coils are preferably placed on each side of the capsule when the capsule is inserted in the beverage producing device for detection. A first emitting coil is so placed close to one side of the capsule (i.e., water inlet side) and the second emitting coil is placed closed to the other side (i.e., liquid delivery side) of the capsule. The two coils can form a Helmholtz-type configuration of coils. It has been noticed that such configuration provides a more uniform signal compared to a single emitting coil. Other configurations of coils are possible.

According to a preferred mode, the different types of capsules correspond to capsules having at least one of the following physical differences: different level of roasting, different coffee granulometry, different blends or origins of coffee, different flavours or any combinations thereof and/or the capsules are designed for delivering different coffee sizes (e.g., ristretto, espresso, lungo, etc.).

The capsules of the invention may contain a beverage ingredient which can be roast and ground coffee, green coffee, soluble coffee, leaf tea, herbal tea, soluble tea, milk powder, cocoa powder, culinary powder, infant formula powder and any combinations thereof.

As a result, the method contemplates the control of at least one parameter related to the preparation of the coffee extract as a function of these types of capsules detected. For instance, the controlled parameter(s) of the beverage producing device can be any of the following ones: water temperature, water volume, prewetting/non-prewetting operation, pressure, flow rate and combinations thereof.

The method also contemplates one or more information steps to the user regarding the type of capsules inserted in the device after its recognition. For instance, the device can provide product information such as the name and/or visual properties corresponding to the type of capsules on a screen or other types of display. Different other types of service steps can be triggered from the capsule recognition step such as promotions, advertising, automatic re-ordering of the capsules.

The invention also relates to a device for identifying capsules in a beverage producing device, comprising:

different types of capsules to be inserted in the beverage producing device wherein each capsule comprises at least one identifier attached thereto or embedded therein,

detecting means for detecting the identifier in the capsule characterized in that:

each identifier is formed of a magnetically-responsive material which composition differs for each type of capsule but is identical for capsules of the same type,

the detecting means comprises at least one emitting coil for emitting a magnetic field and at least one receiving coil for detecting a magnetic signal which is altered by the magnetically-responsive material of the identifiers,

an analyser for analysing and identifying the altered signal, for instance, comparing it to predetermined patterns of altered magnetic signals for recognition of the identifier,

control means, e.g., a control unit, for controlling at least one parameter of the beverage producing device upon identification of the type of capsule corresponding to the recognized identifier.

Preferably, each identifier comprises at least one wire or band of magnetically-responsive materials, e.g., metal alloy as aforementioned. The identifiers of the different series comprises one or more wires having specific alloys compositions so as to provide discriminable altered magnetic signals between the different types of capsules but also the identifiers are identical and placed in the same relative location for the capsules belonging the same types to produce the same signal and to be recognized as belonging to the same type. In particular, the alteration of the magnetic signal is based on a clearly identifiable Barkhausen jump which is generated in the period of the signal. In a mode, the identifier comprises at least two wires providing at least two identifiable Barkhausen jumps.

In order to obtain a reproducible signal of the identifiers, the wires or band of the identifiers of the same type of capsule, are of the same dimension and same relative position onto or in the capsule.

By “magnetically-responsive”, it is here meant that, in a general manner, the identifying element (or also referred in short as: “identifier”) has magnetic or ferromagnetic characteristics in particular Barkhausen characteristics, corresponding to its specific composition and identifiable, or at least discriminable, compared to another composition or relative to one or more magnetic characteristics of reference, under the effect of magnetic flux provided by electromagnetic detecting means.

Further features and advantages of the invention will be explained in relation to the appended drawings in the context of preferred embodiments.

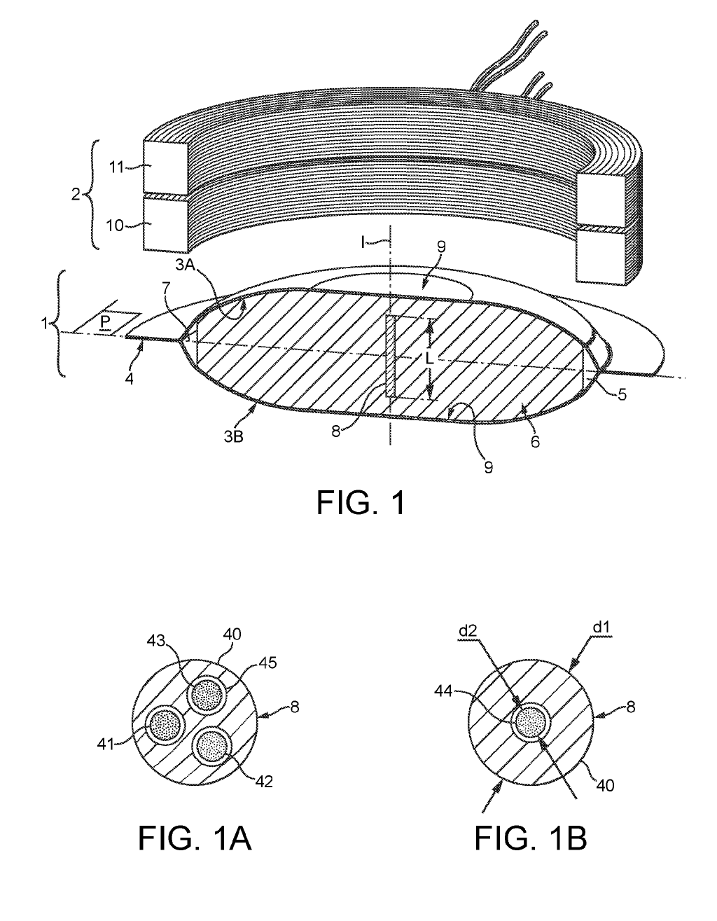

FIG. 1 shows a schematic cross section of the capsule of the invention in conjunction with a detecting device of the beverage producing device;

FIG. 1A is a cross-section and enlarged view of the identifier along plane P of FIG. 1 according to a first embodiment;

FIG. 1B is a cross-section and enlarged view of the identifier along plane P of FIG. 1 according to a second embodiment;

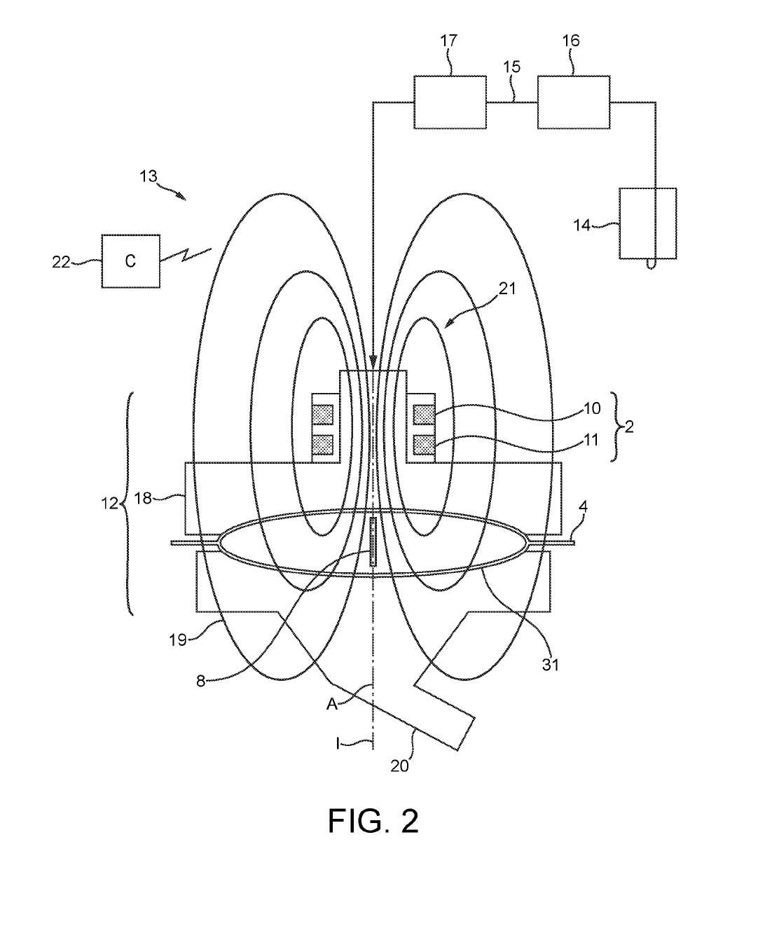

FIG. 2 illustrates a first detection mode in cross section when a capsule of the invention is placed in a beverage producing device;

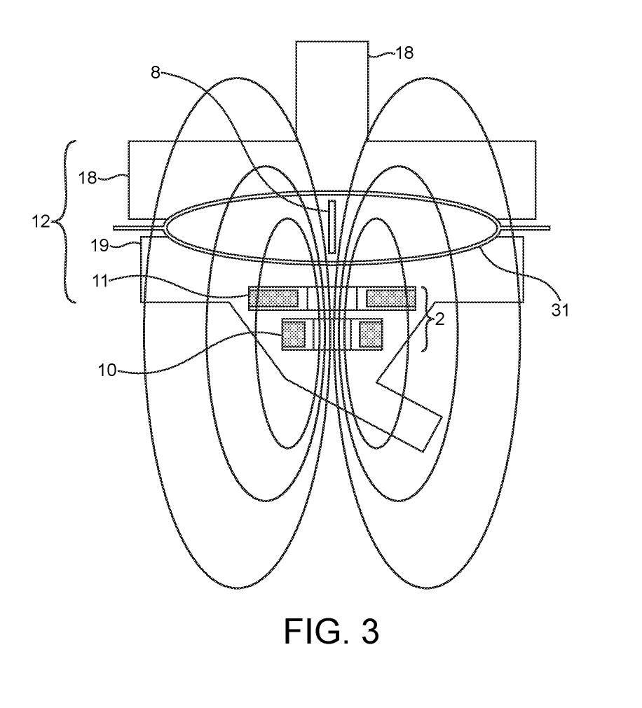

FIG. 3 illustrates a second detection mode with the same capsule in cross section of FIG. 2;

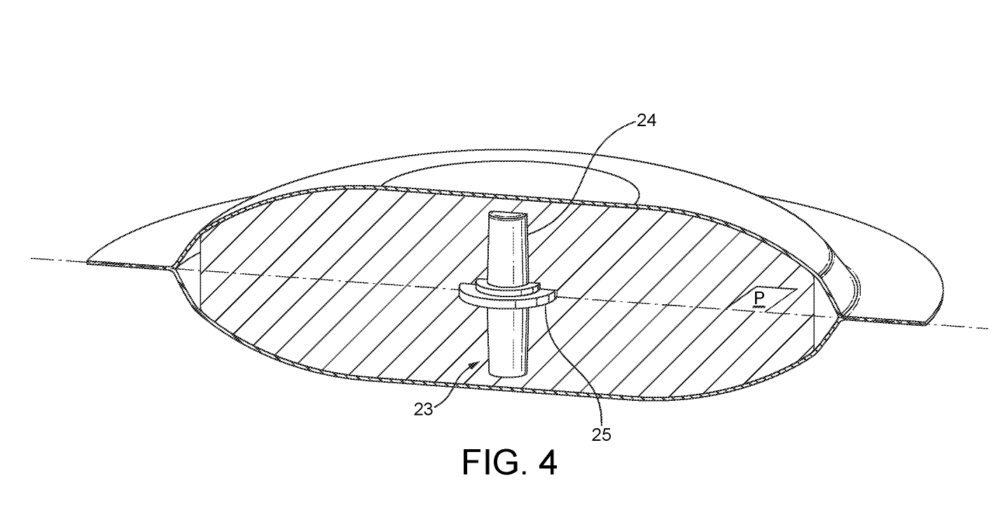

FIG. 4 is a partial cross section view of a capsule according to a second embodiment;

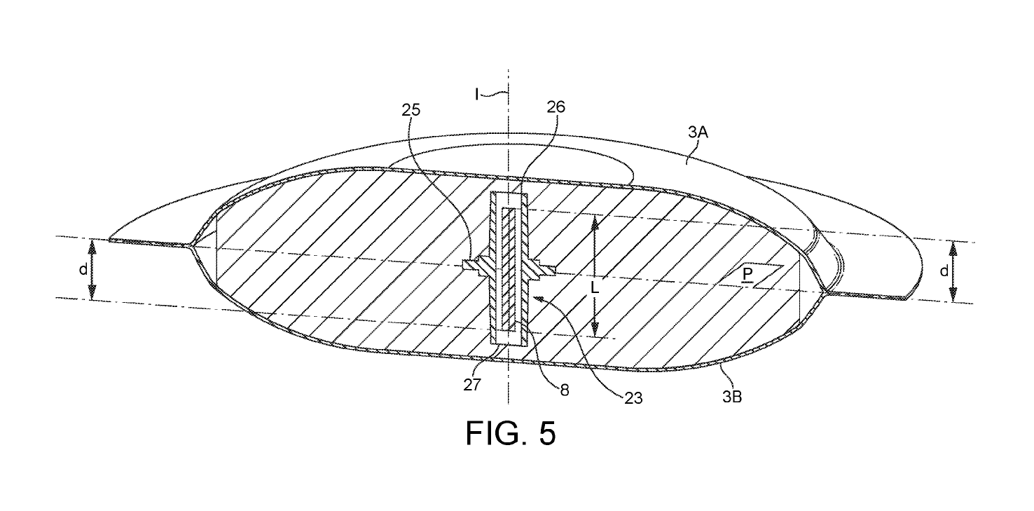

FIG. 5 is a cross sectional view of the capsule of FIG. 4;

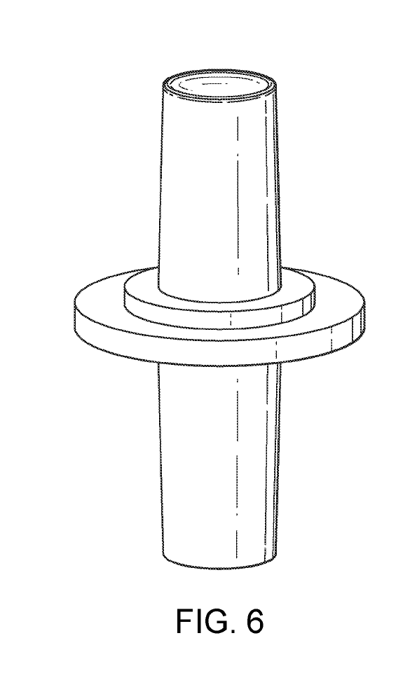

FIG. 6 is a detail of the encased magnetically-responsive element of the invention;

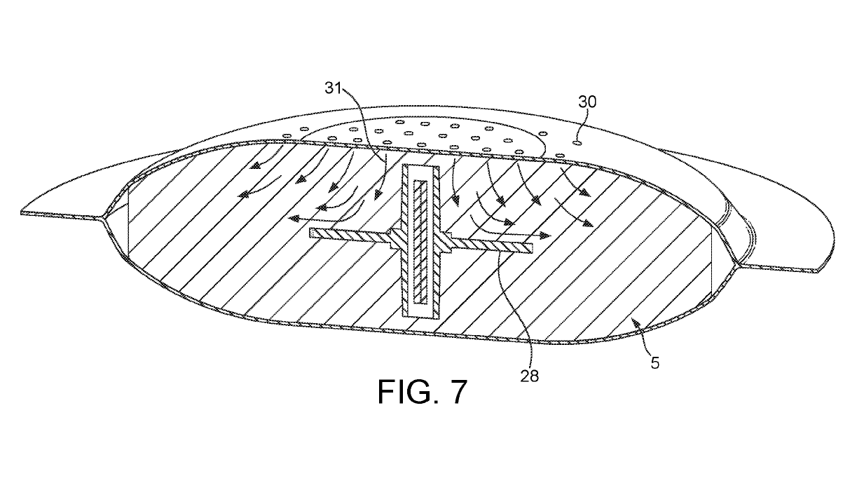

FIG. 7 is a partial cross sectional view of the capsule according to a third embodiment;

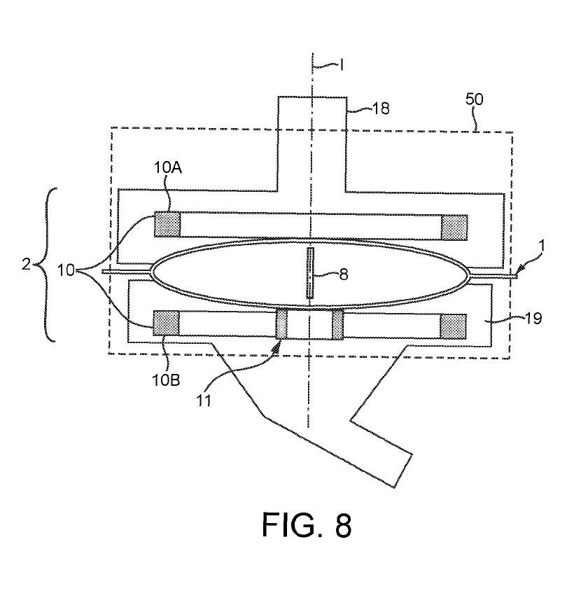

FIG. 8 illustrates another embodiment of the detecting device in a Helmholtz configuration;

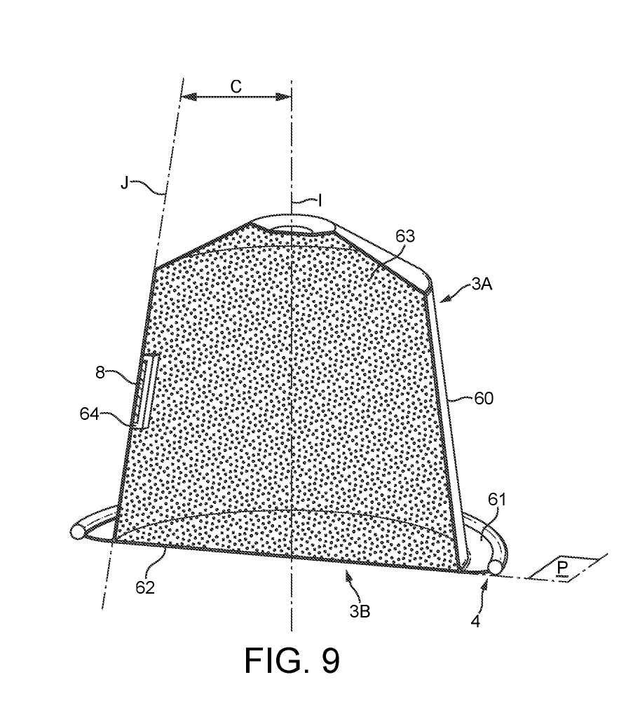

FIG. 9 illustrates a cross section view of a variant of the capsule of the invention;

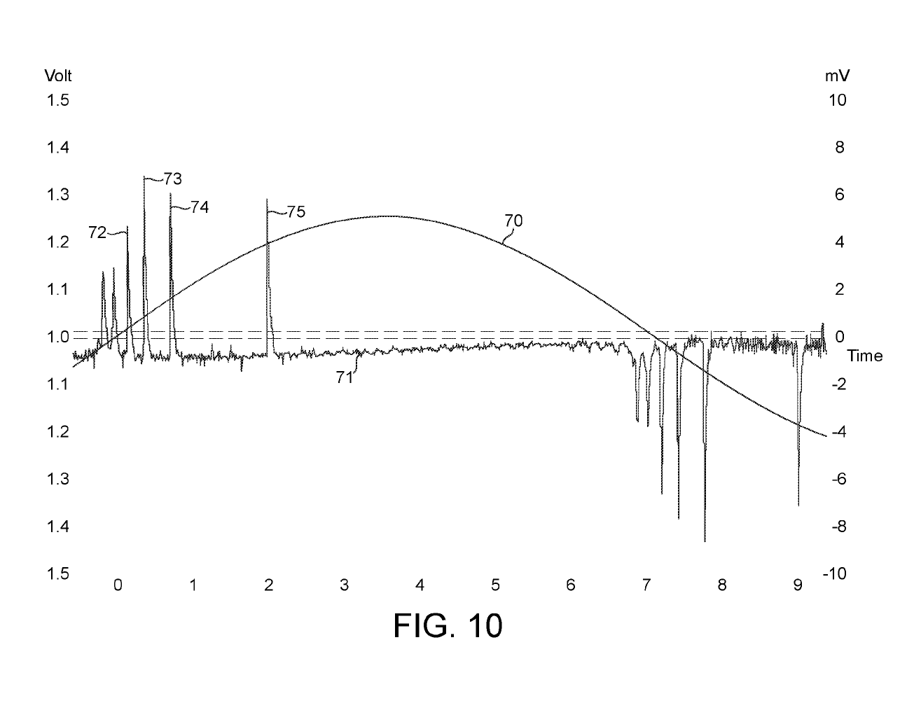

FIG. 10 illustrates an example of the emitted and received time-related voltage signals for a capsule containing an identifier;

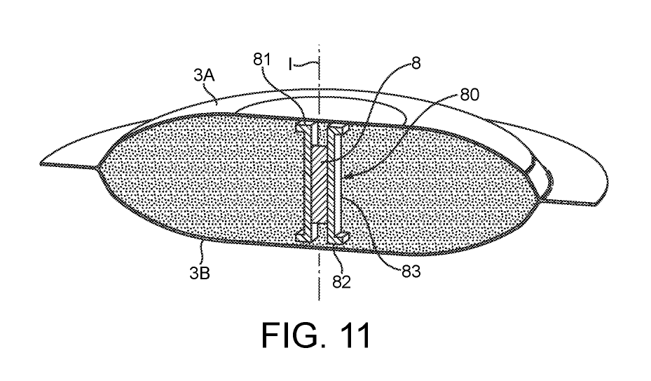

FIG. 11 is a schematic cross section of the capsule according to a variant.

In reference to FIG. 1, the capsule 1 of the invention is intended to be placed under the magnetic influence of a magnetic detecting device 2, or sensor, at a predetermined location and distance. The magnetic detecting device 2, or sensor, is preferably positioned in the beverage producing device (not shown) and is activated when the capsule has reached the detection operational position as will be explained later on. The sensor provides signals to an analyser (not shown) associated to the sensor which can be placed remotely from the sensor in the beverage producing device.

The container of the capsule can be symmetrically formed of a first wall 3A and an opposed wall 3B. The two walls may be permeable or impermeable to the liquid. If impermeable to liquid, the two walls 3A, 3B will be opened, such as by perforation, before or at the time of use in the beverage producing device. The walls may further be impermeable to gas when a gas barrier layer is present in each wall, e.g., a layer of thin aluminium or EVOH. The container may further comprise internal filter layers such as of paper filter for instance. The two walls may also be formed entirely of filter paper.

The two walls 3A, 3B connect together at a seam 4 along a median transversal plane P. The seam can be produced by welding of a peripheral portion of each wall. The seam is preferably resistant to tearing and may be reinforced by additional layers such as cellulose (e.g. paper), polymeric fibres, plastic, rubber and the like. The walls can be flexible for facilitating forming during manufacturing and reducing the packaging material content. The walls can have an inner layer made of a layer compatible to sealing such as oriented polypropylene (OPP). The wall may also contain a decorative layer. In a preferred packaging configuration, each wall is formed of a multi-layer comprising the following layers (from exterior to interior): PET/Colour layer/Adhesive/Aluminium/Adhesive/OPP. The aluminium layer has preferably a thickness between 10 and 80 microns, an OPP (i.e., oriented polypropylene) layer has a thickness of between 5 to 40 microns and PET layer of between 5 and 40 microns.

The walls could also be formed of filter paper and a welding layer for the seam or a combination of aluminium, filter paper and plastic.

The connected walls 3A, 3B delimit an internal cavity 5 which can be at least partially occupied by beverage ingredient 6. In a preferred embodiment, the ingredient is roast and ground coffee. The beverage ingredient is preferably in compacted form such as a tablet. At the periphery of the compacted mass, an annular void 7 might be present. Eventually, the cavity may be placed under partial vacuum before sealing at the seam for preventing the walls to deform outwardly due to gas (e.g., CO₂) release from coffee powder. The resulting general form of the capsule can be a symmetrical lenticular container of substantially convex surface on both sides.

According to the principle of the invention, a contactless identifying element 8 is placed inside the cavity 5, more particularly within the mass 6 of ingredient.

Since the mass is compacted, the element 8 is firmly maintained in a relatively precise location within the capsule. As a result, although the element is invisible from the exterior, the capsule becomes reliably detectable when placed in a predetermined position relative to the detecting means 2.

More preferably, the identifying element is formed of a plastic, e.g., polypropylene, extruded sheath containing magnetically-responsive material, which is substantially aligned relative to the median longitudinal axis I of the capsule which traverses the first and second walls 3A, 3B substantially in their central regions 9. The element can be rigid, semi-rigid or flexible. However, when placed within the capsule it should be at least maintained rectilinear to ensure a correct detection. Due to its central location combined to the mass of ingredients surrounding the element, even if relatively flexible, the element is difficult to bend without damaging the outer package and in that respect it is relatively well protected against external mechanical constraints.

As illustrated in FIG. 1A, the identifier 8 contains a magnetically-responsive element in the form of a sheath 40 containing a particular material composition sensitive to a magnetic field. The material is capable of altering the voltage magnetic signal by producing at least one Barkhausen jump when excited by a magnetic field provided by an electromagnetic emitter. For instance, three or more metal alloy-containing wires 41, 42, 43 coated by a very thin glass coating 45 are embedded in the sheath. The multiplicity of wires provided in the identifier enables to provide a more complex signal, e.g., a plurality of jumps (essentially, one discriminable jump or pulse per wire) therefore more codes available. The wires are preferably separated by a distance of at least 0.5 mm, preferably, a distance between 1 and 2 mm If the wires are too close to each other, the response of one wire is influenced by the presence of the other wire and can generate errors in the interpretation of the signal. The sheath is preferably made of plastic, such as polypropylene, polyethylene, polyamide and combinations thereof. The sheath provides an additional thickness to the wires for facilitating their manipulation and insertion in the capsule. It should be noted that the sheath can take a different cross-section, for instance, a rectangular or triangular form.

In FIG. 1B, the identifier 8 is also formed of a sheath 40 surrounding a single metal alloy-containing wire 44. The diameter (d₂) of a wire is generally of about 25-75 microns. The diameter (d₁) of the sheath depends on the number of wires in the element but it should be sufficient to facilitate handling and positioning in the capsule. Its diameter is typically between about 0.8 and 1.5 mm.

As illustrated in FIGS. 2 and 3, an emitting coil 10 induces, at a certain frequency (e.g., 10 to 150 Hz), magnetic energy into the identifying element 8. Depending on the energy level, the molecular polarity of the wire(s) will change and can thereby be detected as a specific response profile by a receiving coil 11. This effect is known as Barkhausen effect and it can be detected by the receiving coil. Therefore, the response profile of the magnetization or flux density curve changes depending on the particular metal composition of the wire. The alloy material for the wire and its manufacturing method are securely controlled to ensure the repeatability of the altered magnetic signals. Hence, a same wire composition will so produce a repeatable and identifiable profile response.

FIG. 2 shows a first embodiment in which the detecting device 2 is placed at the injection side of the brewing unit 12 of the beverage producing device 13. The device 13 further comprises a water tank 14, a water line 15, a water pump 16 and a water heater 17. The water line 15 communicates with the water feed part 18 of the brewing unit. A controller 22 is also provided in the device for operating the beverage producing machine. The controller can comprise the analyser for the detecting unit 2 for receiving and treating the signals coming from the detecting unit and setting in return the brewing parameters for controlling the elements of the device, e.g., the pump, water heater, etc., accordingly. The analyser can be formed of an electronic microchip that controls the detecting unit and validates the accuracy and validity of the capsule detected.

In other possible applications, the detecting means and analyser could be placed outside the beverage producing device. For instance, these means could be installed at the capsule manufacturing line or at an inventory control area to control the presence the identifier in the produced capsules, identify or sort the capsules.

The capsule 1 of the invention is further maintained in the brewing chamber 19 of the unit by a capsule holder 19 comprising beverage delivery means 20, e.g., a liquid duct. When the capsule is inserted in the brewing unit 12, e.g., on the lower parts 19, the identifier 8 is positioned with its median longitudinal axis I substantially aligned along median axis A of the brewing chamber 31. Identification can be started before or after closing of the brewing chamber 31. Closing of the brewing chamber is carried out by relative movement of the two parts 18, 19 and pinching the capsule along its seam. The detecting means 2 can so be positioned on the injection part 18 about the axis A. The emitting coil 10 and receiving coil 11 are thus in coaxial configuration around axis A. In order to allow detection, the lines of magnetic flux 21 generated by the detecting device 2, (i.e., emitting coils 11, 12) are maintained tangent to axis A, thereby making possible the detection of the identifier. It should be noted that detection could be possible with the median axis I of the capsule forming a low angle of inclination relative to the median axis A of the brewing chamber. Such angle is preferably no larger than 30 degrees, most preferably, no larger than 10 degrees. Therefore detection of the capsule can be carried out during the transfer of the capsule to the brewing chamber. However, most preferably, the capsule is maintained static relative to the beverage producing device during the detection operation.

FIG. 3 is a variant in which the detecting means 2 are placed in the capsule holder 19 still about the median axis A of the brewing chamber to make possible the detection of identifier 8 in the capsule when the capsule is placed in the brewing chamber 31.

In FIGS. 4 to 6, the identifier 8 is embedded in a protective casing 23 such as a thick and rigid plastic element. The casing comprise a tubular longitudinal portion 24 for receiving the portion of sheath (including one or more glass coated wires) inserted therein. The tubular portion 24 is preferably liquid-tightly closed to avoid ingress of liquid during brewing. It should be noted that the magnetically-sensitive identifier 8 can extend on the same distance (d) from each side of plane P so that it offers the same readability with the detecting means whatever the side of insertion of the capsule in the brewing chamber. In an alternative the element 8 could also extend on a different distance (d) from each side of median transversal plane P. The casing could, for instance, also abut on the surface of the ingredient to contact at least one of the covering walls 2, 3. For protection, the identifying element 8 is preferably of a length L smaller than twice the distance d. Furthermore, its ends are preferably inset relative to the ends 26, 27 of the casing.

The casing can be provided with a disc portion 25 which protrudes from the centre of the casing along the central plane P. The disc portion may assure several functions, one of which can be to enhance the position and stability of the casing in the mass of beverage ingredients in particular before compaction of the powder to form the tablet. The casing is less prone to moving during compaction of the ingredient into the tablet and can be better maintained along its extension axis I. Another function of the portion of disc 25 is to force the flow of liquid traversing the capsule from wall 2 to wall 3 to be guided in transversal direction above the portion of disc. It is observed that the portion of disc influences positively the wetting of the beverage ingredients, in particular, for compacted coffee. The portion of disc could also be provided with several through-openings for distributing the flow also through the casing. The casing has closed ends 26, 27 obtained by an internal insert which fills the gap between the identifier 8 and the casing outer portion 23.

Of course, a slight deviation of the identifier relative to the axis I can be tolerated depending on the performance of the detecting means and of the identifier and their locations. In particular, a deviation of +/−45 degrees relative to the longitudinal axis is considered oriented substantially along axis I. However, most preferably, a maximal deviation of +/−10 degrees is recommended. In case, the identifier is inclined relative to axis I of a certain angle (α), the length (L) of the identifier should be maximized to remain readable such that its perpendicular projection, representing L. cos α on axis I, is sufficient to provide an axial component, i.e., preferably between 5 and 10 mm.

In FIG. 7, the casing has a portion of disc 28 of larger diameter than the diameter of disc 25 of the former example. The upper wall 2 is shown when perforated by multiple holes 30 for water to enter in the capsule. The flow of liquid is thus even more forced towards the periphery of the cavity 5 (See arrows 31).

In general, the disc portion (28) may also be traversed by multiple apertures to distribute liquid through the capsule more uniformly. The apertures may present different diameters depending on the flow pattern to be achieved in the capsule.

FIG. 8 illustrates a beverage brewing unit according to another embodiment of the invention with a capsule inserted therein. For the detecting device, the electromagnetic emitter 10 is here configured as Helmholtz coils, respectively first and second coils 10A, 10B. The first and second emitting coils 10A, 10B are separated by a distance equivalent or close to the radius of the circular loops of the coils, which produces a homogeneous magnetic field in the median plane between the two coils. The two coils are preferably conducting circular coils each having N turns and each carrying a current separated by a distance preferably substantially equivalent to the radius of the circular loops in order to produce a homogeneous magnetic field in the median plane between the two circular coils. A receiving coil 11 is placed inside the second coil 10B. Each emitting coils may, for instance, be formed of a copper coil wire of diameter of 0.1 mm and with about 1000 turns. The receiving coil may be a shorter-diameter coil, e.g., made of a copper wire of diameter of about 0.1 mm and with about 1300 turns. In order to reduce the interference with outside electromagnetic sources, a shielding 50 against electromagnetic waves can be provided about the detecting device 2. The distance between the receiving coil and the capsule should be relatively small to ensure a correct detection of the received signal. Such shielding can be DC motor magnets, for instance, or a Faraday cage. The Faraday cage can be formed of a metallic housing placed around the brewing unit. It may also be a metallic lattice or a metallic painting.

In FIG. 9, the capsule of the present invention is non-symmetrical at its seam 4 and comprises a first covering wall 3A forming a cup-shaped body 60 with a lateral flange-like rim 61 extending outwardly. A second covering wall 3B forming a bottom wall 62 is sealed at seam 4 onto the rim 61. The bottom wall 62 can be a liquid-tight foil or be a filter element. The capsule contains beverage ingredient 63 such as ground coffee, tea, cocoa powder, milk powder and combinations thereof. The beverage ingredient may be in loose form in the capsule although eventually compressed to a certain extent before filling the body. In this mode, a magnetically sensitive element 8 is positioned and secured at the inner sidewall of the capsule. The element also extends as one or more wires oriented substantially along a linear direction J forming a short angle C relative to median axial direction I of the capsule. The element 8 is substantially orthogonal to transversal plane P passing via the seam 4. The direction J forms an angle of preferably less than 10 degrees relative to axis I, most preferably an angle between 0 and 8 degrees. The element 8 can be fixed to the inner side of the capsule by an adhesive label 64. It should be noted that the label can form the support for the wire(s) or for an extruded element including the wire(s) as described previously in relation to FIGS. 1A and 1B. In the present embodiment, the identifying element 8 is protected by the rigid body but remains oriented substantially orthogonal to the longitudinal axis I for offering proper reading by the detecting means 2 placed at the brewing unit as aforementioned.

The identifying method is carried out according to the following principles. The emitting coil (or coils) placed in the vicinity of the brewing unit, in the relative position described previously, excites the identifier to produce a sine-wave exciting signal. The emitted signal 70 (FIG. 10) without alteration forms a sinusoidal voltage signal representative of the electromagnetic field produced by the emitting coil. The signal is altered by the identifier in such a way that at least one Barkhausen jump affects the signal at predetermined phase locations of the signal, e.g., by a clear identifiable jump at a certain position of the sine wave. The Barkhausen jump is due, as known per se, to a fast remagnetisation of the wire-element which produces a particular response to the applied magnetic field. If the voltage response is detected during this process in the receiving (“pick-up”) coil(s), it materializes into one or more sharp peaks of the voltage signal related to time. This alteration is detected and analysed by comparing the difference resulting from the magnetic reference signal and the altered magnetic signal. More particularly, the position (i.e., coercivity) of the jump or jumps (or “peaks”) is measured and compared to different ranges of positions (i.e., coercivity ranges). For example, the difference between the emitted AC signal 70 of the emitter and the altered signal received by the receiver is represented by the signal's curve 71 illustrated on FIG. 10. More particularly, the position (i.e., coercivity) of the jump or jumps (or “peaks” 74-75) on curve 71 is measured and compared to different ranges of positions (i.e., coercivity ranges). Each range is thereby linked to a particular code corresponding to a type of capsule. Other parameters such as the amplitude and duration of the jump could be measured and identified to reference parameters to fine-tune the identification of the code.

FIG. 11 illustrates another possible variant of the capsule of the invention. In this embodiment, the identifying element 8 is maintained in a predetermined location inside the cavity of the capsule by an additional positioning member 80. The additional positioning member 80 determines the position of the identifying element 8 in the cavity, preferably, along longitudinal axis I of the capsule. In this case, the beverage ingredient does not create a support for the identifying element and could be either compacted or loose beverage ingredient (such as ground coffee) or a combination thereof. The positioning member can be an elongated bracing means having at least one of its end 81, 82 in contact or connected to a covering wall 3A or 3B of the capsule. Preferably, a first end 81 comes in abutment against the covering wall 3A and its other end 82 comes in abutment or is connected to the second covering wall 3B. The positioning member 80 can further comprise a tubular portion 83 that encases the identifying element 8. The identifying element could be press fitted and/or glued into the tubular portion 83. Of course, the positioning member can take many other different shapes. For example, the two ends 81, 82 could be sealed to the covering walls. It should also be noticed that at least one of the covering walls could be open at the centre of these ends such as if the ends are sealed to the wall and hollow or tubular in their centre such forming a kind of conduit for the identifying element.

Although the invention has been described in relation to preferred modes, other possible variations are possible in particular in view of the detecting technology and the type of identifier. Also, the capsule may take different forms which are not necessarily symmetrical along plane P. For example, the capsule can have a cup-shaped body closed by a membrane. The capsule can also be formed of partially rigid packaging materials.

1.-15. (canceled)

16. A method for identifying capsules in a beverage producing device which comprises:
providing a capsule that includes at least one identifier comprising a magnetically-responsive material with the identifier attached to the capsule or embedded therein;
providing in the beverage producing device detecting means that includes at least one emitting coil and at least one receiving coil;
emitting a magnetic signal from the at least one emitting coil;
positioning the identifier in the magnetic field thereby altering the magnetic signal resulting therefrom;
detecting an altered signal by the receiving coil; and
identifying the capsule according to the alteration provided to the magnetic signal.

17. The method according to claim 16, wherein the magnetic signal is altered by the identifier providing at least one Barkhausen jump affecting the signal as resulting from the magnetically-responsive material placed in the magnetic field.

18. The method according to claim 17, which further comprises comparing such Barkhausen jump with a number of reference magnetic patterns; each one corresponding to a certain type of capsule.

19. The method according to claim 17, wherein the magnetically-responsive material is formed from at least one wire or band.

20. The method according to claim 19, wherein the material is formed from a combination of wires or bands.

21. The method according to claim 19, wherein the wire or band comprises a magnetically-responsive alloy forming an element of predetermined dimensions and specific composition.

22. The method according to claim 21, wherein the wire is a micro-wire having a length of between 5 and 15 mm and a diameter of between 10 and 100 microns.

23. The method according to claim 16, wherein the identifier has a predetermined relative location onto or in the capsule.

24. The method according to claim 16, which further comprises placing the emitting and receiving coils in the vicinity of the brewing unit for detecting the identifier of the capsule when the capsule is inserted or localized in the brewing unit.

25. The method according to claim 16, wherein the magnetic field is provided by two emitting coils.

26. The method according to claim 16, wherein a first emitting coil is placed close to one of the sides of the capsule and a second emitting coil is placed close to the opposite side of the capsule.

27. The method according to claim 16, which further comprises providing different types of capsules that correspond to capsules having at least one of the following physical differences: different coffee granulometry, different roasting levels, different blends of coffee, different origins of coffee, different flavours, different sizes of beverages or any combinations thereof.

28. The method according to claim 16, which further comprises controlling at least one parameter of the beverage producing device based on the recognized capsule.

29. The method according to claim 28, wherein the at least one parameter is water temperature, water volume, a prewetting operation, a non-prewetting operation, pressure, water flow rate or any combination thereof.

30. A device for identifying capsules in a beverage producing device, comprising:
different types of capsules to be inserted in the beverage producing device wherein each capsule comprises at least one identifier attached thereto or embedded therein, with each identifier comprising magnetically-responsive material which differs for each type of capsule but is identical for capsules of the same type;
detecting means for detecting the identifier in the capsule, the detecting means comprising at least one emitting coil for emitting a magnetic field and at least one receiving coil for detecting a magnetic signal which is altered by the magnetically-responsive material of the identifiers;
an analyser for analysing the altered signal, comparing it to predetermined patterns of altered magnetic signals for recognition of the identifier; and
control means for controlling at least one parameter of the beverage producing device upon identification of the type of capsule corresponding to the recognized identifier.

31. The device according to claim 30, wherein each identifier comprises at least one wire comprising a magnetically-responsive material.

32. The device according to claim 30, wherein the wires of the identifiers for the same type of capsules, are of the same dimension and same relative position onto or in the capsule.

33. The device according to claim 30, wherein the at least one parameter is water temperature, water volume, a prewetting operation, a non-prewetting operation, pressure, water flow rate or any combination thereof.
